(19) United States
(12) Patent Application Publication
(10) Pub. No.: US 2026/0042503 A1
(43) Pub. Date: Feb. 12, 2026

(54) CHAIN LUBRICATION TOOL

(71) Applicant: Andrew Greig, Epping (AU)

(72) Inventor: Andrew Greig, Epping (AU)

(21) Appl. No.: 19/101,279

(22) PCT Filed: Aug. 7, 2022
(86) PCT No.: PCT/AU2023/050737

§ 371 Date: Feb. 5, 2025

(30) Foreign Application Priority Data
Aug. 5, 2022 (AU) 2022902199

(51) Int. Cl. B62J 31/00; F16H 57/05; F16N 3/02; F16N 7/02

(52) U.S. Cl. CPC B62J 31/00; F16H 57/05; F16N 3/02; F16N 7/02; F16N 2210/33

(57) ABSTRACT

A tool (10) for lubricating a chain (50), e.g. of a motorbike or bicycle, includes a block that defines a chain passage (22) through the block for receiving the chain (50). A first lubricant channel (438) through the block can be used to apply lubricant (56) into the chain passage where it is directed onto the chain. A second lubricant channel (300) can collect excess lubricant to allow the lubricant to drain and be collected for tidier operation. Lubricant channels can be provided for both aerosol and liquid lubricants.

### FIELD OF THE INVENTION

This disclosure relates to a device for lubricating chains.

### BACKGROUND OF THE INVENTION

Chains for motorcycles, bicycles, etc. require lubrication in order to function properly. A chain is comprised of links. The links typically include side plates that support pinned rollers therebetween. Proper application of lubricant can be laborious because every link needs to be adequately lubricated. Even a single improperly lubricated link can lead to faulty operation of the chain. Spray lubricants have been developed which allow faster application of lubricant to the chain, but the use of sprays leads to considerable wastage and mess. Spray cans can be fitted with nozzle hoses or straws that allow the spray to be directed to individual links, but this becomes laborious and still leads to wastage.

What is required is an improved system, device and method for providing lubricant to a chain.

### SUMMARY OF THE INVENTION

In one aspect of the disclosure, there is provided a chain lubrication tool including:
a body,
a chain passage passing through the body and configured to accommodate a chain;
at least one first lubricant channel through the body, the at least one first lubricant channel including:
   at least one first exterior opening on an exterior of the body;
   at least one first chain passage opening in the chain passage;
at least one second lubricant channel through the body, the at least one second lubricant channel including:
   at least one second chain passage opening in the chain passage; and
   at least one second exterior opening on an exterior of the body.

In one aspect of the disclosure, there is provided a method for lubricating a chain using a chain lubrication tool as outlined above. The method may include receiving a chain into the chain passage, receiving lubricant into at least one of the first lubricant channel or the second lubricant channel so that lubricant exiting into the chain passage is received onto the chain.

### BRIEF DESCRIPTION OF THE DRAWINGS

Reference will now be made, by way of example only, to specific embodiments and to the accompanying drawings in which:

FIG. 1 shows an embodiment of a chain lubrication tool in use on a chain;

FIG. 2 shows a lower perspective of a lower block of the chain lubrication tool;

FIG. 3 shows an upper perspective of the lower block;

FIG. 4 shows a side view of the lower block;

FIG. 5 shows the internal lubricant channels through the base of the lower block;

FIG. 6 shows an upper perspective of an upper block of the chain lubrication too;

FIG. 7 shows a lower perspective of the upper block;

FIG. 8 shows a bottom perspective view of the upper block;

FIG. 9 shows a roller;

FIG. 10 shows a roller pin;

FIG. 11 depicts a chain lubrication tool in an open configuration for receiving a chain;

FIG. 12 depicts a chain lubrication tool in use on a chain in a first orientation for applying liquid lubricant onto a chain; and

FIG. 13 depicts a chain lubrication tool in use on a chain in a second orientation (inverted orientation) for applying lubricant from an aerosol onto a chain;

FIG. 14 shows a top perspective view of an alternative embodiment of a lubrication tool having dual exterior openings for multi-sided operation;

FIG. 15 shows a top perspective view of an alternative embodiment of a first block of a lubrication tool having dual exterior openings for liquid lubricant and aerosol lubricant; and

FIG. 16 is a bottom perspective view of the first block of FIG. 15.

### DETAILED DESCRIPTION OF THE INVENTION

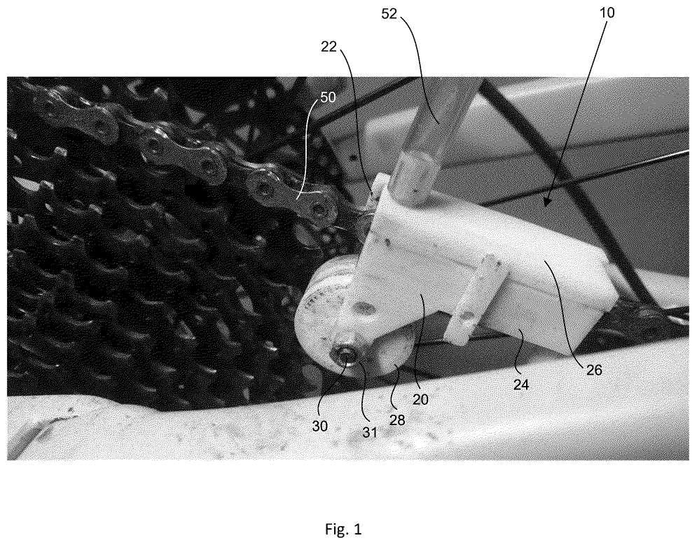

A chain lubrication tool 10 is shown generally in FIG. 1. The chain lubrication tool 10 is depicted in use mounted on the chain 50 of a bicycle. The tool 10 includes a housing block 20. The housing block 20 has a first (upper) block 26 and a second (lower) block 24. Between the upper block 26 and lower block 24 there is an internal passage 22 through the housing block 20. The internal passage 22 is a chain passage or chain channel and is configured to allow a chain to pass through the housing block 20. To receive a chain into the passage 22, the housing block may be opened. In one embodiment, the first block 26 and the second block 24 are separate pieces that can be attached together, e.g. through a pivotable hinge joint, to define the internal passage between them. The second block 24 supports a roller 28 that is connected to the second block by a pin 30. The roller 28 facilitates movement of the chain through the tool by contacting the cogs of the cluster of the bicycle as the cogs rotate through movement of the chain.

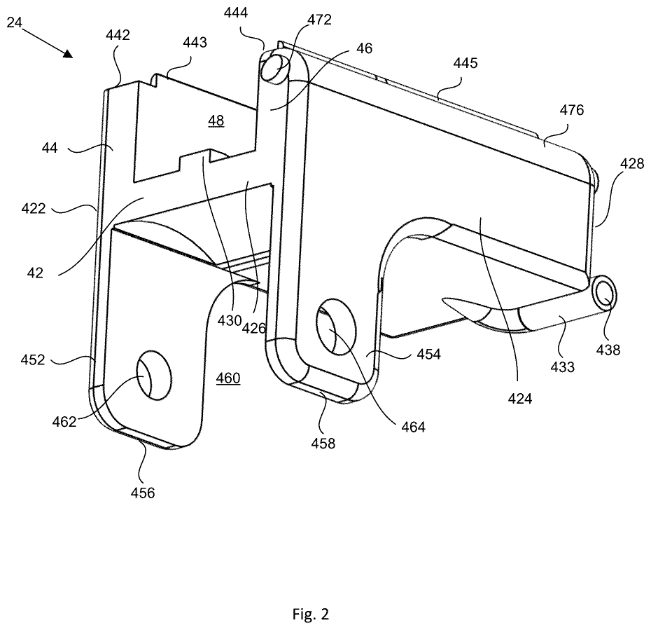

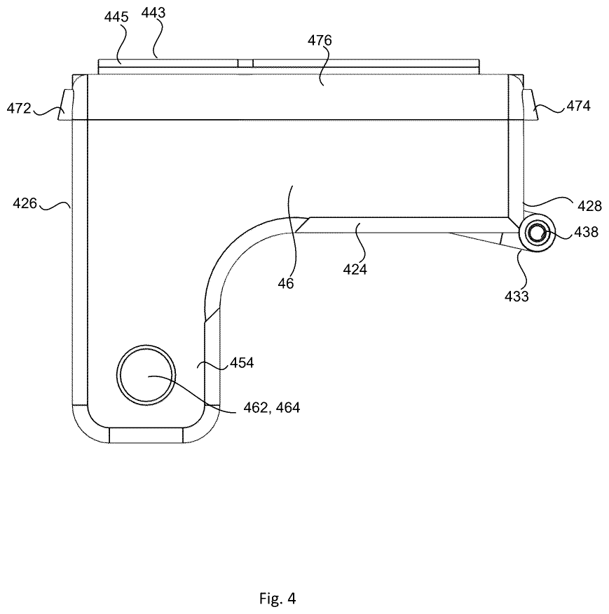

The second block is shown in more detail in FIGS. 2 to 4. The second block 24 includes a base 42. The base 42 has edges 422, 424, and ends 426, 428. Extending upwards from each edge 422, 424 of the base 42 are opposed side walls 44, 46. The side walls extend upwards to free ends 442, 444. The free ends 442, 444 each have a longitudinal rib 443, 445 toward an inner edge of the free end.

The second block has a longitudinal axis or length defined by the side walls 44, 46. The side walls 44, 46 define a chain passage 48 between the side walls from a first open end 486 to a second open end 488. The chain passage 48 extends between the sidewalls 44, 46 in the longitudinal direction.

In use, a chain is accommodated into the chain passage. The chain passage 48 through the lower block 24 has an open top end 482. The width of the chain passage 48 is sufficient to accommodate the width of a chain that will typically be used in the device 10. The chain passage 48 may be manufactured at different widths to accommodate different types of chains. Similarly, the height of the side walls 44, 46 is sufficient to accommodate the height of a chain that is to be used in the device 10.

The base includes central guide ribs 430, 432 that extend a short distance upwards from an chain passage surface 434 of the base (upper surface of the base as depicted). The central guide ribs have a width that substantially matches a roller width of the chain and can therefore be accommodated between the side plates of the chain. The guide ribs 430, 432 serve as chain locators to guide and centralise the chain passing through the chain passage 48.

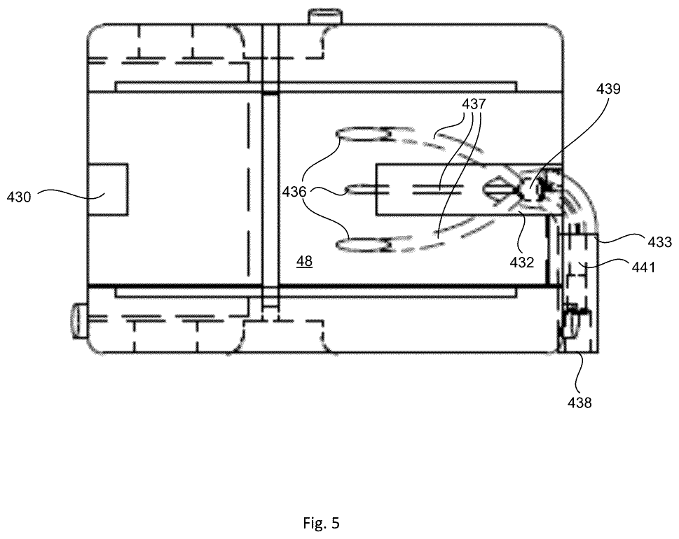

The chain passage surface 434 of the base 42 may include one or more chain passage openings 436 that lead to one or more channels through the base 42. The channel(s) connect to an exterior conduit 433 at an end 428 of the base 42. The exterior conduit 433 has an exterior opening 438. The exterior conduit 433 extends from the end 428 of the base 42 and along to a first side of the tool. FIG. 5 shows, in dotted line, the closed internal channels 437 through the base 42 that start individually at the chain passage openings 436 and converge 439 within the base 42 to form a single internal channel through the conduit 433 to the exterior opening 438.

Extending downward of the base 42 from the edges 422, 424 and adjacent the end 426 of the base 42 are side arms 452, 454. The side arms 452, 454 extend from the base 42 to free ends 456, 458. The side arms 452, 454 are opposed and define a gap 460 between them. Each side arm 452, 454 includes an aperture 462, 464 located substantially adjacent the free ends 456, 458 of the sidearms 452, 454. The apertures 456, 458 are configured to receive the roller pin 30. The apertures may be configured to receive the roller pin in a variety of ways. For example, the pin may be configured to press fit into the apertures, the pin may be configured to be secured with a nut or split pin. Alternatively, one or both of the apertures 456, 458 may be internally threaded to receive a threaded end of the roller pin 30. Further details of the roller pin will be described below.

The second 24 block may include one or more engagement elements for facilitating connection of the second block 24 to the first block 26. In one embodiment, one of the side walls, e.g. side wall 46, includes circular projections 472, 474 that project longitudinally outward of the ends of the side wall 46. The projections 472, 474 provide a first aspect of a hinge joint for hingedly connecting the second block 24 to the first block 26. The upper outer edge 476 of the side wall 44 may be curved along its length to facilitate rotation in the hinge joint.

On the outer face 479 of the opposite side wall 46 is a projection 480 that provides a catch for securing the device 10 in a closed configuration.

The second block 24 may be made of plastic, wood, metal or any suitable material. In one embodiment, the second block 24 may be molded from a plastic material such as nylon. In one embodiment, the second block 24 may be molded or 3-D printed.

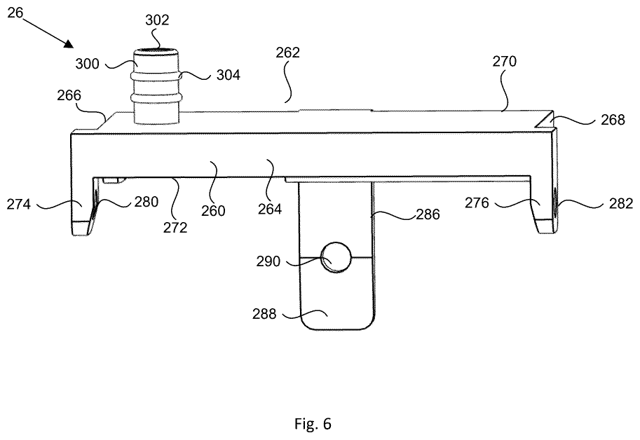

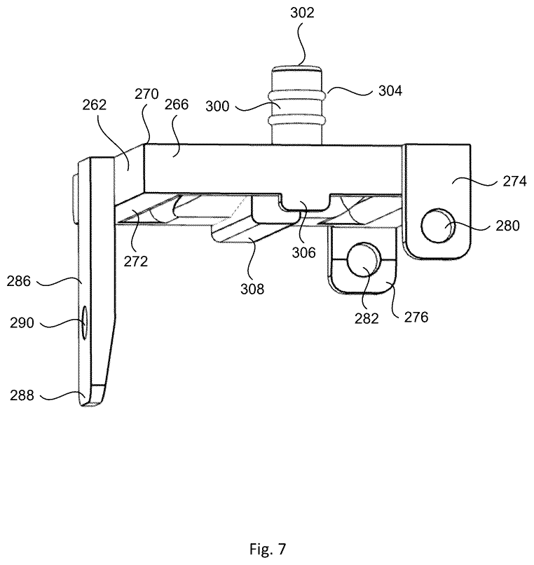

The first block 26 is shown in more detail in FIGS. 6 to 8. The first block 26 includes a generally rectangular body 260 having edges 262, 264, and ends 266, 268, an exterior surface 270 (upper surface as depicted) and a chain passage surface 272 (lower surface). Hinge arms 274, 276 extend downward from the ends 266, 268 adjacent edge 264. The hinge arms include apertures 280, 282 that receive the projections 472, 474 when the first block 26 is connected to the second block 24. From the centre of the edge 262 opposite edge 264 there is an arm 286 that extends downward. A distal end 288 of the arm 286 includes an aperture 290 that is sized to match the projection 480.

Extending from the upper surface 270 adjacent end 266, there is a nozzle 300 that provides an exterior opening 302 to an internal channel through the first block 26. The nozzle may have circumferential ribs 304 that facilitate engagement with a hose, as will be described in more detail below.

The lower surface 272 has central longitudinal ribs 306, 308 that act as chain guide ribs in a similar manner to the chain guide ribs 430, 432 of the base 42.

The lower surface 272 is recessed toward the end 266. The internal channel from the opening 302 terminates at a chain passage opening 310 within the recess 312. The opening 310 is centered laterally. While only a single chain passage opening 310 is shown, multiple chain passage openings may be provided. The internal passage from the exterior opening 302 may diverge within the body of the first block 26 to the multiple outlets.

The first block 26 may be made of plastic, wood, metal or any suitable material. In one embodiment, the first block 26 may be molded from a plastic material such as nylon. In one embodiment, the first block 26 may be molded or 3-D printed.

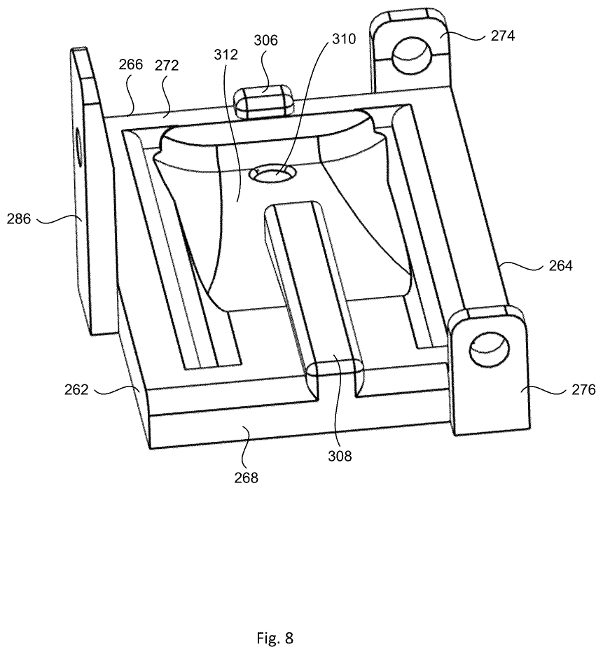

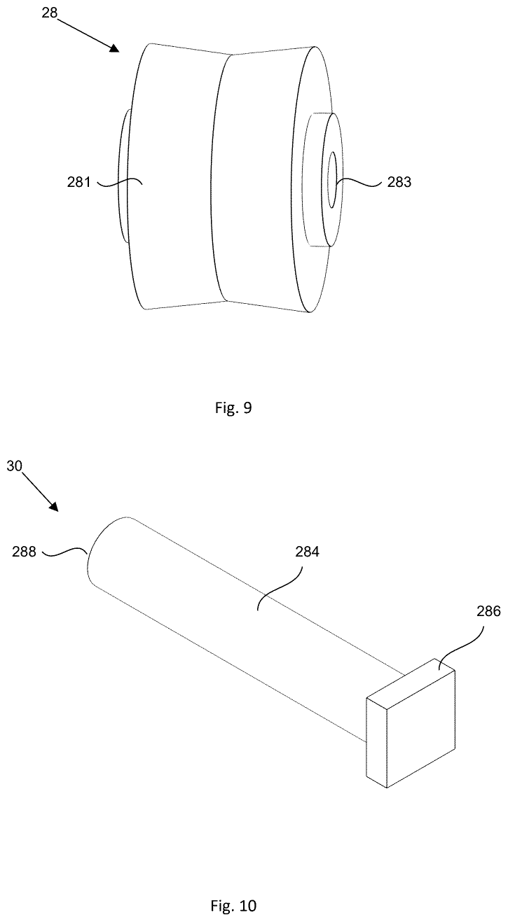

FIG. 9 shows an embodiment of the roller 28 that can be received between into the gap 460 between the side arms 452, 454 of the second block 24. The roller 28 is cylindrical with a circular outer surface 281. An aperture 283 passes through the roller along its axis for receiving the roller pin 28 to enable rotational motion on the roller pin 28. The roller 28 may be made of plastic, metal, wood or any other suitable material. In one embodiment, the roller 28 is plastic molded or 3-D printed. FIG. 10 shows an embodiment of the roller pin 30 that can be used to secure the roller 28 to the second block through the apertures 462, 464. The pin has a smooth tubular body 284 and a head 286. The distal end 288 of the pin 30 may be pushed through a first aperture 462, then through the roller 30, then through the second aperture 464 until the distal end 288 projects externally of the aperture 464. The distal end 284 may be flared and include a split that can be compressed to allow the distal end to fit through the apertures 462, 464 but then will naturally expand to prevent removal of the pin. The pin 28 can be forceably removed by first compressing the distal end 284. Rather than a split pin, the distal end 284 of the pin 30 may be threaded and be secured by a nut 31 as shown in FIG. 1. Alternatively, one or both of the apertures 462, 464 of the side arms 452, 454 may be threaded to receive and secure the end of the pin. Alternative fastening mechanisms for securing the roller between the side arms 452, 454 will be apparent to the person skilled in the art. It should be noted that while the Figures depict the roller attached to the second block 24, the roller can, alternatively, be connected to the first block by the use of side arms on the first block if preferred.

The first block 26 can be attached to the second block 24 by flexing the hinge arms 274, 276 of the first block 26 sufficiently to receive the projections 472, 474 of the second block 24. The first block 26 is thus able to pivot relative to the second block. The first block 26 provides an openable enclosure or lid to the chain passage 48. In the open position, a chain 50 can be received into the chain passage 48 (FIG. 11). In the closed position, the chain passage is closed by the lid and the chain is secured within the tool. The first block 26 can be secured in the closed position by engaging the aperture 290 of the locking arm 286 with the projection 480 of the second block 24. Between the open and closed positions, the first block may rotate by at least 90 degrees and potentially up to approximately 150 degrees to facilitate access to the chain passage.

While a hinge joint between the first block 26 and second block 24 is depicted, other connections between the first and second blocks are contemplated within the scope of the present embodiments. For example, the first and second blocks may be completely separated each time the chain is inserted or removed from the chain passage 22. Catches, clips, detents or the like may be used to provide releasable engagement between the first and second blocks. In an alternative embodiment, the first and second blocks may be integrally formed, e.g. with a thin flexible plastic hinge between the first and second blocks that allows the first and second blocks to pivot apart to expose the chain passage 22.

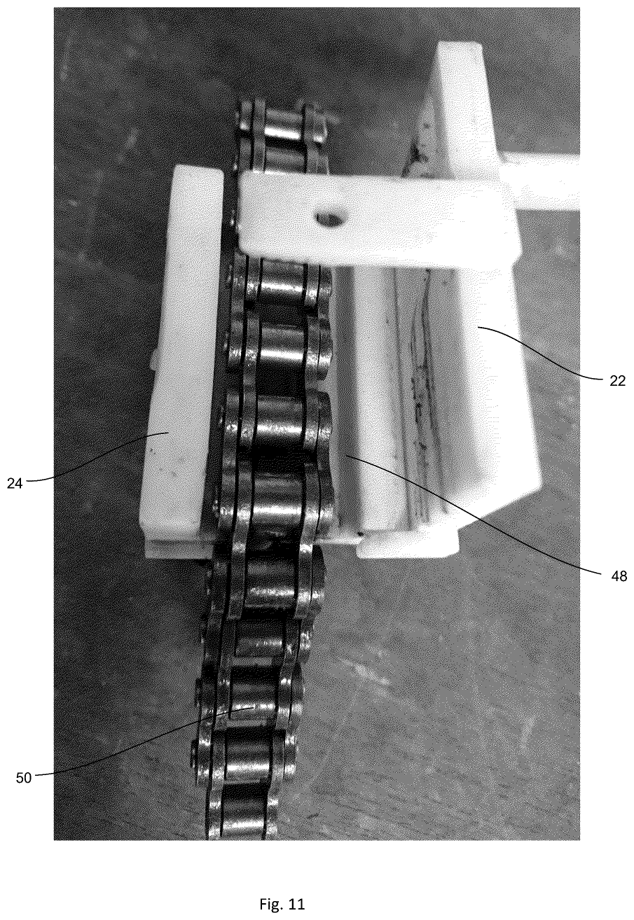

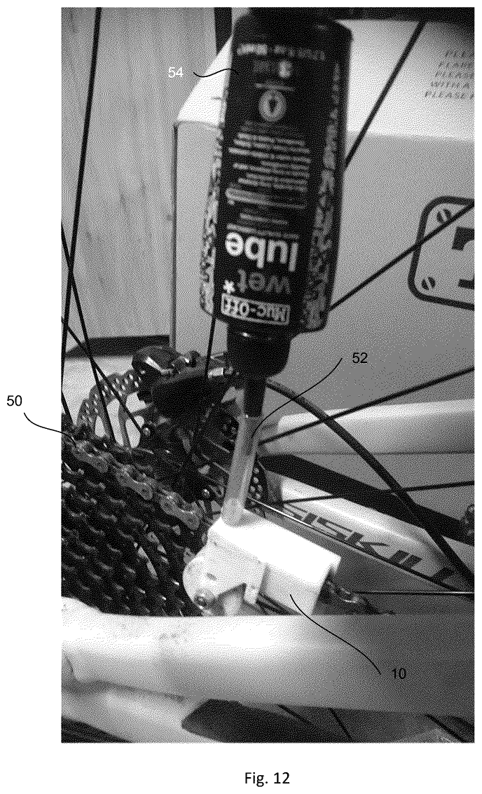

Returning to FIG. 1, the operation of the chain lubrication tool on a bicycle chain is shown. The tool is attached on the upper rung of chain 50. A hose 52 may be connected to the nozzle 300 and a lubricant supply 54 may be connected to the hose 52, as shown in FIG. 12. Lubricant may flow due to gravity, or by pressurizing the supply, e.g. by squeezing the supply. The lubricant passes through the exterior opening 302, into the through internal channel(s) of the first block 26 and exits through the chain passage opening 310 into the chain passage above the chain rollers so that the chain rollers receive an amount of lubricant. While the lubricant is flowing, the chain is rotated through the chain passage, causing each link of the chain to receive an amount of lubricant. Excess lubricant will drain into the chain passage openings 436 of the second block 24 and will exit the conduit 433 where the excess lubricant can be easily captured.

If it is desired to use an aerosol lubricant, an aerosol hose can be connected to the opening 438 and pressurized lubricant can be applied to the chain through the conduit 433. The chain passage openings 436 are arranged laterally across the chain passage to distribute the lubricant to where it is needed, specifically the central roller of the chain and the sides of the chain where there is movement between the side plates of one link and the next, thus three chain passage openings 436 are illustrated.

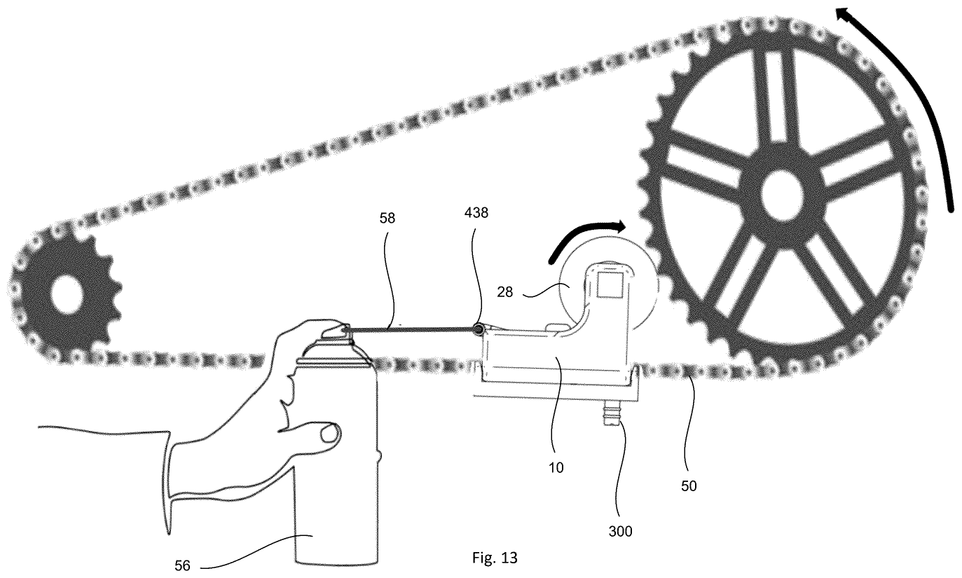

FIGS. 1 and 12 show the tool 10 being used in a particular configuration, specifically, on the upper chain rung and with a liquid lubricant supply. In this configuration, and with the chain rotating backwards to allow the cluster/cogs to freewheel without rotating the tyre (anticlockwise viewed from outside) the roller engages against the rear cluster/cogs. In some circumstances, it may be more convenient to locate the tool 10 on the lower chain rung. Alternatively, it may be desirable to apply lubricant from a pressurized container, such as an aerosol. FIG. 13 shows the tool 10 located on the lower rung of chain 50. For this configuration, the tool 10 is inverted relative to the orientation shown in FIGS. 1 and 12. In this inverted orientation, and with the tool located on the lower chain rung, the idler roller 28 contacts the gears of the cycle which facilitates rotation of the chain. The exterior opening 438 at the side of the tool can form an inlet and can receive a hose 58 connected to an aerosol nozzle of a lubricant can 56. The inner part of opening 438 may be tapered to facilitate the insertion of the hose end 58. Pressurized lubricant can be delivered from the aerosol 56 through the conduit 433 and into the internal channels of the second block 24. The chain passage openings 436 of the second block 24, which are located above the chain 50 in the inverted configuration project lubricant onto the chain. As stated above, the chain passage openings 436 are arranged to distribute the lubricant to where it is most needed on the chain. The idler roller 28 keeps the lubricator tool 10 in position allowing the operator to use one hand to rotate the chain in an anticlockwise direction and one hand to operate the aerosol can, keeping both hands away from the moving chain.

In this configuration, the recess 312 forms a well that angles toward the chain passage opening 310 of the first block 26 that may capture lubricant shed from the chain and transfer it through the internal channels of the first block 26 to the nozzle opening 302 where it may be tidily captured.

It can be seen that the tool 10 can provide lubricant directly to the links of a chain while the chain is retained on the cycle, which may be a bicycle, motorcycle, or indeed, any apparatus having a chain requiring lubrication. Advantages include that the lubricant is applied to the chain directly and excess lubricant is captured. A further advantage is that a single tool has configurations for applying both liquid and aerosol based lubricants. Regardless of orientation, the roller positions or holds the tool in place against the sprockets or gears, allowing the operator's hands to be free, so that one hand can apply lubricant while the other rotates the chain. The tool 10 can conveniently be used on the upper or lower rung of the chain by simply flipping the tool.

While the housing block 20 is shown and described as two separate pieces attached by a pivoting connection, other forms of connection will be apparent to the person skilled in the art. For example, the pieces may press fit together using complementary engagement mechanisms. In an alternative embodiment, the upper and lower pieces may be permanently joined through a thin strip of flexible plastic, or a hinge joint.

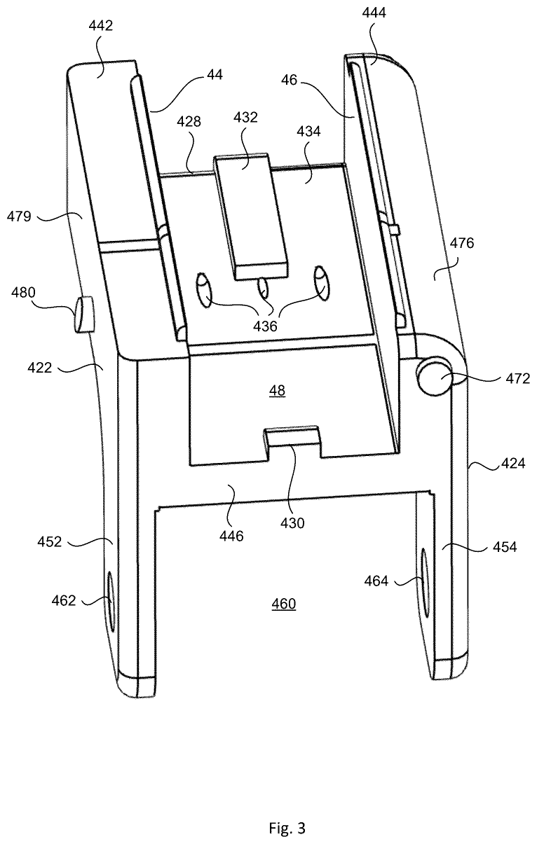

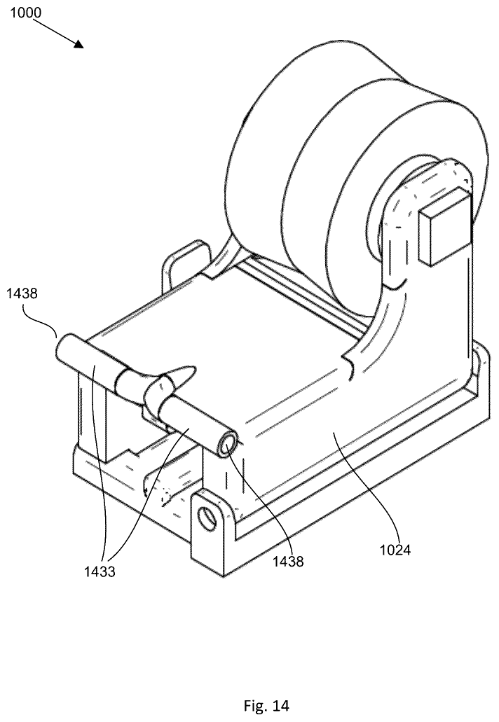

A further embodiment of the invention is depicted in FIG. 14 in which the lubrication tool of the earlier embodiments is modified to have a dual-conduit system facilitating dual-sided operation. FIG. 14 shows a modified lubrication tool 1000 in the inverted configuration shown in use in FIG. 13 which allows an aerosol lubricant to be applied from a pressurized spray can through a connecting straw or tube. The block 1024 includes dual conduits 1433 each having an opening 1438. The two openings 1438 extend from each side of the tool. The dual conduits converge within the body of the block 1024 and then form channels similar to the channels 437 leading to openings 436 as shown in FIGS. 3 and 5. Because each side of the tool has an opening 1438 and conduit 1433, the dual conduit system allows the tool to be used with an aerosol attached to either side, thus preventing the operator from having to cross over the chain, regardless of the orientation of the tool 1000. That is, the operator is always able to access an opening 1438 on the outside of the chain. A stopper may be used to close the other of the apertures 1438 to prevent the lubricant from escaping without passing through the chain tool and onto the chain.

While the figures depict the use of an aerosol can when the conduits 433, 1433 are located above the chain, because the aerosol relies on pressure from the aerosol and not gravity, good lubrication can also be achieved from an aerosol even when the tool is used in the configuration shown in FIGS. 1 and 12, i.e. with the conduits 433, 1433 located below the chain.

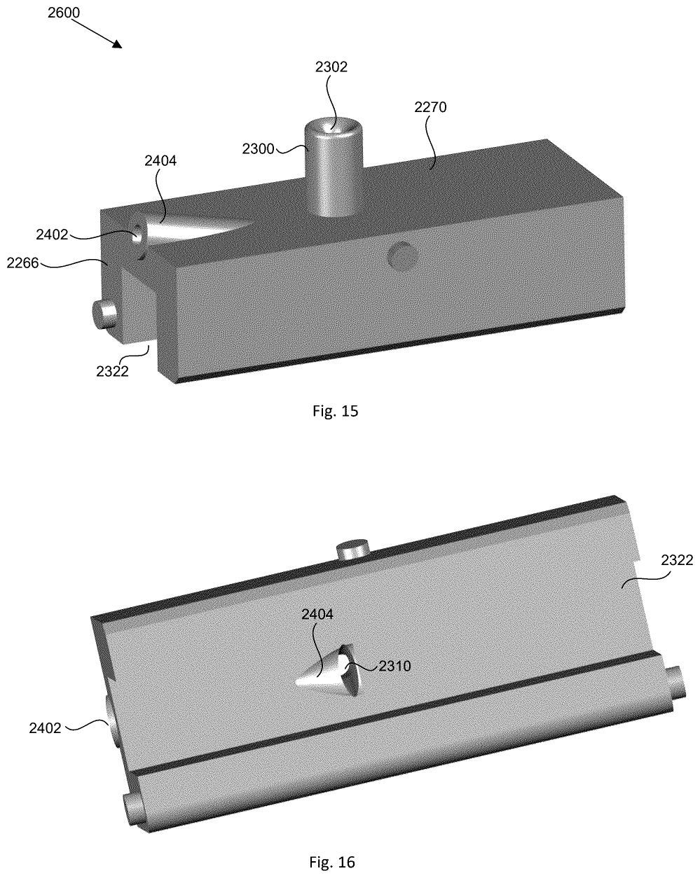

An alternative embodiment 2600 for the first block is depicted in FIGS. 15 and 16. In this embodiment, the nozzle 2300 with its exterior opening 2302 is located in approximately the center of the upper exterior surface 2270 as depicted. A lubricant channel passes vertically through the block 2600 to a chain passage opening 2310 in the chain channel 2022. The block 2600 has a second exterior opening 2402 in an end 2266 of the block. A second lubricant channel 2404 passes through the block from the second exterior opening 2402 and joins with the first chain channel opening 2310. In use, the first lubricant channel may be used for applying liquid lubricant to a chain located in the chain channel as described previously. In addition, the second lubricant channel may be used to apply aerosol lubricant to the chain channel. Stoppers can be used to plug the unused lubricant channel to prevent escape of lubricant.

Terms of orientation such as upper, lower, left, right, forward, back, horizontal, vertical, etc. are used herein to provide a clear and concise description with reference to the drawings only. Such terms are not intended to limit the scope of the invention nor its use to a particular orientation.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by any following claims.

What is claimed is:

1. A chain lubrication tool including:
a. a body,
b. a chain passage passing through the body and configured to accommodate a chain;
c. at least one first lubricant channel through the body, the at least one first lubricant channel including:
i. at least one first exterior opening on an exterior of the body;
ii. at least one first chain passage opening in the chain passage;
d. at least one second lubricant channel through the body, the at least one second lubricant channel including:
i. at least one second chain passage opening in the chain passage; and
ii. at least one second exterior opening on an exterior of the body.

2. The chain lubrication tool of claim 1 wherein the body is openable to receive a chain into the chain passage.

3. The chain lubrication tool of claim 2 wherein the body comprises a first block hingedly attached to a second block.

4. The chain lubrication tool of claim 3 wherein the at least one first lubricant channel is disposed in the first block and the at least one second lubricant channel is disposed in the second block.

5. The chain lubrication tool of claim 4 wherein, in use the at least one second chain passage opening collets waste lubricant from inside the chain passage and channels the waste lubricant to the at least one second exterior opening.

6. The chain lubrication tool of claim 1 wherein in use, the chain lubricant can be provided to the chain passage through either the at least one first exterior opening or the at least one second exterior opening.

7. The chain lubrication tool of claim 1 wherein the at least one second exterior opening comprises a first second exterior opening disposed on a first side of the chain lubrication tool and a second second exterior opening disposed on a second side of the chain lubrication tool.

8. The chain lubrication tool of claim 1 wherein the chain passage include at least one chain guide that, in use, aligns a chain within the chain passage with at least one of the at least one first chain passage opening and the at least one second chain passage opening.

9. The chain lubrication tool of claim 1 including a roller that in use, positions the tool against one or more sprockets or gears associated with the chain to facilitate rotation of the chain through the chain passage.

10. A method for lubricating a chain using the chain lubrication tool of claim 1, the method including receiving a chain into the chain passage, and receiving lubricant into at least one of the first lubricant channel or the second lubricant channel so that lubricant exiting into the chain passage is received onto the chain.

11. The method of claim 10 including positioning a roller of the chain lubrication tool against one or more sprockets or gears on which the chain is mounted and rotating the chain to pass the chain through the chain passage.

12. The method of claim 10 comprising connecting a lubricant supply to the first exterior opening and providing lubricant to the chain under gravity.

13. The method of claim 10 comprising connecting an aerosol to the at least one second exterior opening and providing pressurized lubricant to the chain through the at least one second exterior opening.
